(19) United States
(12) Patent Application Publication
(10) Pub. No.: US 2026/0322110 A1
(43) Pub. Date: Oct. 15, 2026

(54) OVER-CURRENT PROTECTION DEVICE

(71) Applicant: Polytronics Technology Corporation, Hsinchu (TW)

(72) Inventors: Yung-Hsien CHANG, Douliu City (TW); Chia-Yuan Lee, Hsinchu City (TW); CHEN-NAN LIU, Pitou Township (TW); CHENG-YU TUNG, Tainan City (TW); HSIU-CHE YEN, Taoyuan City (TW); Yao-Te Chang, Linnei Township (TW)

(21) Appl. No.: 19/244,250

(22) Filed: Jun. 20, 2025

(30) Foreign Application Priority Data
Apr. 11, 2025 (TW) 114113709

(51) Int. Cl. H02H 9/02; H01C 1/08; H01C 7/02

(52) U.S. Cl. CPC H02H 9/026; H01C 1/08; H01C 7/027

(57) ABSTRACT

An over-current protection device includes an electrode layer and a heat-sensitive layer. The heat-sensitive layer is laminated between a top metal layer and a bottom metal layer of the electrode layer, and includes a polymer matrix and an conductive filler. The polymer matrix includes a polyolefin-based polymer. The conductive filler includes a metal-containing material dispersed in the polymer matrix, thereby forming an electrically conductive path in the heat-sensitive layer. In addition, the metal-containing material has a core metal and a carbon layer. The carbon layer covers more than 60% of the total surface area of the core metal.

### BACKGROUND OF THE INVENTION

### (1) Field of the Invention

The present application relates to an over-current protection device, and more specifically, to an over-current protection device with low electrical resistivity and high stability in resistance change.

### (2) Description of the Related Art

Because the electrical resistance of conductive composite materials having a positive temperature coefficient (PTC) characteristic is very sensitive to temperature variation, they can be used as the materials for current sensing devices and have been widely applied to over-current protection devices or circuit devices. More specifically, the electrical resistance of the PTC conductive composite material remains extremely low at normal temperatures, so that the circuit or battery cell can operate normally. However, when an over-current or an over-temperature situation occurs in the circuit or cell, the electrical resistance will instantaneously increase to a high electrical resistance state (e.g., at least above 10⁴Ω), which is the so-called “trip”. Therefore, the over-current will be eliminated so as to protect the cell or the circuit device.

The basic structure of an over-current protection device consists of a PTC material layer with two electrodes bonded to two opposite sides of the PTC material layer. The PTC material layer includes a matrix and a conductive filler. The matrix consists of at least one polymer, and the conductive filler consists of carbon black and/or at least one metal compound filler, uniformly dispersed in the matrix. As described above, the positive temperature coefficient characteristic of the over-current protection device primarily comes from the PTC material layer, and therefore various electrical characteristics of the over-current protection device can be adjusted by modifying the PTC material layer.

In order to attain lower electrical resistivity, the conductive filler often includes a certain proportion of the metal compound filler as described above. However, metal compound fillers with higher hardness are prone to lattice defects caused by friction or collision during processing, resulting in higher and less stable resistance when subsequently used in conductive fillers. For example, tungsten carbide is often subjected to machining processes under conditions of high temperature and high shear force, which can easily lead to surface defects and the formation of tungsten or ditungsten carbide (W₂C). It is noted that tungsten or ditungsten carbide is easily oxidized to form tungsten oxide (WO₃), which may absorb water to generate tungstic acid (WO₃·nH₂O), thereby making the filler powder acidic and more prone to forming hydrogen bonds with water. Therefore, when tungsten carbide is used in the conductive filler, it is often affected by environmental humidity and exhibits higher resistance or resistance instability. In addition, when the over-current protection device is processed into a SMD (surface-mount device) type device, the insulating layer of it is often made of epoxy resin. During thermal processing, epoxy resin is easily affected by humidity, which can cause the popcorn effect, leading to the formation of bubbles or delamination at the interface between the insulating layer and the metal layer (or the composite layer).

Accordingly, there is a need to develop a new type of over-current protection device with low electrical resistivity and excellent resistance stability.

### SUMMARY OF THE INVENTION

In accordance with an aspect of the present invention, an over-current protection device includes an electrode layer and a heat-sensitive layer. The electrode layer has a top metal layer and a bottom metal layer. The heat-sensitive layer is laminated between the top metal layer and the bottom metal layer. The heat-sensitive layer exhibits a positive temperature coefficient (PTC) characteristic and includes a polymer matrix and a conductive filler. The polymer matrix includes a polyolefin-based polymer. The conductive filler includes a metal-containing material dispersed in the polymer matrix, thereby forming an electrically conductive path in the heat-sensitive layer. The metal-containing material has a core metal and a carbon layer covering the core metal. The total surface area of the core metal is taken as 100%, and the carbon layer covers more than 60% of the total surface area of the core metal.

In an embodiment, the carbon layer completely wraps the core metal, such that the core metal is enclosed by at least one layer of the carbon layer.

In an embodiment, a pH value of the metal-containing material ranges from 6 to 9.

In an embodiment, a maximum diameter of the metal-containing material is greater than 8 μm.

In an embodiment, the maximum diameter of the metal-containing material ranges from 8 μm to 13.5 μm.

In an embodiment, the total volume of the heat-sensitive layer is taken as 100%, with the polyolefin-based polymer accounting for 50% to 60% and the conductive filler accounting for 40% to 50%.

In an embodiment, the core metal is tungsten carbide.

In an embodiment, the polyolefin-based polymer is selected from the group consisting of low density polyethylene (LDPE), medium density polyethylene (MDPE), high density polyethylene (HDPE), linear low-density polyethylene (LLDPE), polypropylene, and polybutene.

In an embodiment, the heat-sensitive layer does not include a flame retardant.

In an embodiment, the polymer matrix does not include a fluoropolymer, wherein the fluoropolymer is selected from the group consisting of polyvinylidene difluoride, polytetrafluoroethylene, ethylene-tetrafluoroethylene copolymer, tetrafluoroethylene-hexafluoro-propylene copolymer, perfluoroalkoxy modified tetrafluoroethylenes, poly(chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, and vinylidene fluoride-hexafluoropropylene-tetrafluoroethylene terpolymer, and a mixture or copolymer of combinations thereof.

In an embodiment, the over-current protection device has a first resistance change rate lower than 1.2. The over-current protection device has an initial electrical resistance; the over-current protection device has a first electrical resistance when cooled back to room temperature after a thermal treatment for one cycle; and the first resistance change rate is obtained by dividing the first electrical resistance by the initial electrical resistance.

In an embodiment, the over-current protection device has a second resistance change rate lower than 1.5. The over-current protection device has an initial electrical resistance; the over-current protection device has a second electrical resistance when cooled back to room temperature after a thermal treatment for three cycles; and the second resistance change rate is obtained by dividing the second electrical resistance by the initial electrical resistance.

In an embodiment, the over-current protection device has a third resistance change rate lower than 1.8. After the thermal treatment for three cycles, the over-current protection device is then placed in an environment with a temperature/humidity of 85° C./85% for 504 hours and has a third electrical resistance; and the third resistance change rate is obtained by dividing the third electrical resistance by the second electrical resistance.

In an embodiment, the over-current protection device has a fourth resistance change rate lower than 2. After the thermal treatment for three cycles, the over-current protection device is then placed in an environment with a temperature/humidity of 40° C./95% for 504 hours and has a fourth electrical resistance; and the fourth resistance change rate is obtained by dividing the fourth electrical resistance by the second electrical resistance.

In an embodiment, at room temperature, the over-current protection device has a current endurance per unit area ranging from 0.6 A/mm² to 1.1 A/mm², and has a power endurance per unit area ranging from 3.6 W/mm² to 7 W/mm².

In an embodiment, at 85° C., the over-current protection device has a current endurance per unit area ranging from 0.3 A/mm² to 0.7 A/mm², and has a power endurance per unit area ranging from 2.2 W/mm² to 5 W/mm².

In an embodiment, the over-current protection device has a top-view area ranging from 2 mm² to 81 mm².

In an embodiment, the heat-sensitive layer has a thickness ranging from 0.12 mm to 0.19 mm.

### BRIEF DESCRIPTION OF THE DRAWINGS

The present application will be described according to the appended drawings in which:

FIG. 1 illustrates a structure of a metal-containing material;

FIG. 2 illustrates the formation of carbon layer on the surface of the metal-containing material under various conditions;

FIG. 3 shows a cross-sectional view of an over-current protection device in accordance with an embodiment of the present invention; and

FIG. 4 shows the top view of the over-current protection device shown in FIG. 3.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

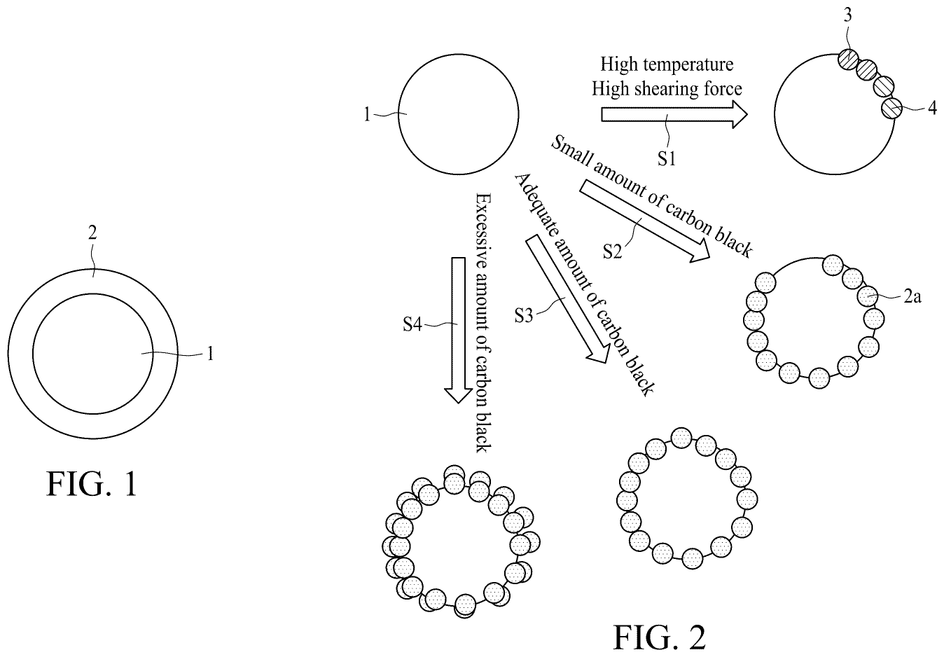

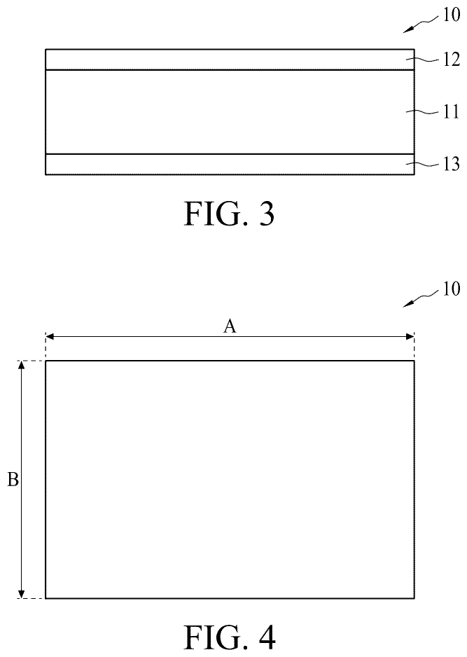

Please refer to FIG. 1 and FIG. 2. FIG. 1 shows an exemplary structure of the metal-containing material of the present invention. FIG. 2 shows the formation of carbon layer on the surface of the metal-containing material under various conditions. In one basic aspect of the over-current protection device, it includes a composite layer and metal layers disposed above and below it, respectively (as shown in FIG. 3 and FIG. 4, described hereinafter). The composite layer mainly consists of a polymer and a conductive filler, wherein the conductive filler includes the metal-containing material, thereby stably forming an electrically conductive path in the un-tripped state of the device. To achieve excellent electrical characteristics in the over-current protection device, the present invention aims to modify the metal-containing material within the conductive filler. As shown in FIG. 1, the metal-containing material of the present invention has a core metal 1 and a carbon layer 2 that wraps around the surface of the core metal 1. The core metal 1 is a filler with high metal activity (e.g., tungsten carbide), which is prone to lattice defects on its surface caused by exposure to high temperatures and shear forces during various processing procedures. Coated with the carbon layer 2, the core metal 1 can effectively maintain its structural integrity. Please refer to FIG. 2. FIG. 2 illustrates how the presence or the abundance of the carbon layer 2 affects the core metal 1 under various conditions (i.e., step S1, step S2, step S3, and step S4), wherein the carbon layer 2 consists of carbon black particles 2a. In the step S1, the core metal 1 is not coated with the carbon layer 2, and exposure to a high temperature and high shear force leads to the formation of defects on its surface, resulting in the generation of impurities including a first impurity particle 3 and a second impurity particle 4. The first impurity particle 3 may be ditungsten carbide (W₂C), and the second impurity particle 4 may be tungsten oxide (WO₃). For example, the aforementioned surface defects may cause the transition of tungsten carbide into ditungsten carbide during the process, and then ditungsten carbide is oxidized to form tungsten oxide. In other words, a large number of unexpected impurities can easily form on the surface of the core metal 1 without the carbon layer 2, significantly affecting the purity of the core metal 1 and further impacting the electrical characteristics of the entire device. However, more of carbon layer 2 does not necessarily lead to better results. Please refer to the steps S2, S3, and S4 in FIG. 2 for further explanation. In the step S2, the core metal 1 and a small amount of carbon black are co-sintered, resulting in partial coverage of the entire surface of the core metal 1 by the carbon black particles 2a; in this condition, part of the core metal 1 remains exposed to the environment, and the protection provided by carbon black is insufficient. In the step S3, the core metal 1 and an adequate amount of carbon black are co-sintered, resulting in complete coverage of the entire surface of the core metal 1 by the carbon black particles 2a; in this condition, the core metal 1 is entirely enclosed by the carbon black particles 2a, forming a single layer of the carbon layer 2 and thereby providing sufficient protection. In the step S4, the core metal 1 and an excessive amount of carbon black are co-sintered, resulting not only in complete coverage of the entire surface of the core metal 1 by the carbon black particles 2a but also in the formation of multiple layers of the carbon layer 2; in this condition, the excessive carbon black leads to higher electrical resistance, thereby compromising the electrical conductivity of the device.

Based on the above, the metal-containing material of the present invention can be applied to the over-current protection device. Please refer to FIG. 3 and FIG. 4. FIG. 3 shows the basic aspect of the over-current protection device 10 of the present invention. The over-current protection device 10 includes a heat-sensitive layer 11 and an electrode layer. The heat-sensitive layer 11 has a top surface and a bottom surface, and the electrode layer has a top metal layer 12 and a bottom metal layer 13 attached to the top surface and the bottom surface, respectively. Therefore, the heat-sensitive layer 11 physically contacts the top metal layer 12 and the bottom metal layer 13, and is laminated therebetween. In an embodiment, the top metal layer 12 and the bottom metal layer 13 may be composed of the nickel-plated copper foils or other conductive metals. In addition, the heat-sensitive layer 11 includes a polymer matrix and a conductive filler. The polymer matrix is an electrical insulator sensitive to heat, and the conductive filler is a conductor, by which the heat-sensitive layer 11 exhibits a PTC characteristic. During the un-tripped state of the over-current protection device 10, the conductive filler is uniformly dispersed in the polymer matrix, and particles of the conductive filler connect to each other in series, thereby forming an electrically conductive path; however, the polymer matrix rapidly expands and the crystalline region is transformed into the amorphous region when the over-current protection device 10 is exposed to high temperatures, thereby cutting off the electrically conductive path.

As described above, the conductive filler of the present invention includes the metal-containing material. The metal-containing material has the core metal 1 and the carbon layer 2 covering the core metal 1, wherein the core metal 1 may be tungsten carbide. The total surface area of the core metal 1 is taken as 100%, and the carbon layer 2 covers more than 60% of the total surface area of the core metal 1, preferably between 70% and 100%. It is understood that when the carbon layer 2 covers 100% of the total surface area of the core metal 1, the carbon layer 2 completely wraps the core metal 1. Preferably, the core metal 1 is enclosed by at least one layer of the carbon layer 2.

To verify the coverage of the carbon layer 2, the present invention further measures the pH value and particle size distribution of the metal-containing material. In some embodiments, the pH value of the metal-containing material ranges from 6 to 9, such as 6, 6.3, 7, 7.2, 7.9, 8, 8.4, or 9. In contrast, the pH value of the metal-containing material without the carbon layer 2 is below 3, which is quite acidic. Apparently, the metal-containing material of the present invention is protected by the carbon layer 2, preventing the formation of unexpected impurities during processing, and thereby maintaining a neutral or slightly basic pH value. As for the particle size, in some embodiments, the maximum diameter of the metal-containing material is greater than 8 μm, such as between 8 μm and 13.5 μm. In contrast, the maximum diameter of the metal-containing material without the carbon layer 2 is 7.59 μm. This suggests that as the carbon layer 2 wraps the core metal 1, the size of the metal-containing material of the present invention increases.

Regarding the composition of the PTC material, a polyolefin-based polymer is selected as the major constituent of the polymer matrix of the present invention, and the aforementioned metal-containing material is selected as the major constituent of the conductive filler. The polyolefin-based polymer is selected from the group consisting of low density polyethylene (LDPE), medium density polyethylene (MDPE), high density polyethylene (HDPE), linear low-density polyethylene (LLDPE), polypropylene, and polybutene. In one embodiment, the total volume of the heat-sensitive layer 11 is taken as 100%, and the polyolefin-based polymer accounts for 50% to 60%, preferably ranging from 53% to 55%, such as 53%, 53.5%, 54%, 54.5%, or 55%; and the conductive filler accounts for 40% to 50%, preferably ranging from 45% to 47%, such as 45%, 45.5%, 46%, 46.5%, or 47%.

It is noted that the heat-sensitive layer 11 of the present invention does not include a flame retardant. The flame retardant is selected from the group consisting of zinc oxide, antimony oxide, aluminum oxide, silicon oxide, calcium carbonate, magnesium sulfate, barium sulfate, magnesium hydroxide, aluminum hydroxide, calcium hydroxide, and barium hydroxide. Conventionally, the flame retardant is used to reduce the flammability of the over-current protection device 10, enabling it to withstand higher currents or powers without burnout. In some cases, magnesium hydroxide even acts as an inner filler for neutralization. However, in the absence of the flame retardant, the present invention can still withstand higher currents or powers without burnout, and moreover, there is no need to consider the issue of neutralization. In this way, the composition of the PTC material is improved through its simplicity. That is, the present invention reduces the complexity of the composition while still exhibiting excellent electrical characteristics. In some embodiments, the polymer matrix of the over-current protection device 10 does not include a fluoropolymer. The fluoropolymer is selected from the group consisting of polyvinylidene difluoride, polytetrafluoroethylene, ethylene-tetrafluoroethylene copolymer, tetrafluoroethylene-hexafluoro-propylene copolymer, perfluoroalkoxy modified tetrafluoroethylenes, poly(chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, and vinylidene fluoride-hexafluoropropylene-tetrafluoroethylene terpolymer, and a mixture or copolymer of combinations thereof. It is understood that the polyolefin-based polymer of the present invention has higher crystallinity, and therefore, its resistance recovery capability is better than that of the fluoropolymer. Moreover, the melting point of the polyolefin-based polymer is often lower than that of the fluoropolymer, and correspondingly, its protection temperature (i.e., trip temperature) of the polyolefin-based polymer is also lower. As a result, in some embodiments, since the over-current protection device 10 of the present invention is designed for a low protection temperature and high resistance stability, the fluoropolymer is excluded.

By improving the heat-sensitive layer 11 as described above, the over-current protection device 10 of the present invention exhibits several advantageous electrical characteristics. The details are provided below.

In the present invention, the over-current protection device 10 exhibits excellent resistance stability in response to various environmental factors. This resistance stability can be assessed through resistance change rate (i.e., first resistance change rate, second resistance change rate, third resistance change rate, and fourth resistance change rate, as described hereinafter). A lower resistance change rate indicates a better ability of the over-current protection device 10 to return to a low electrical resistance state, demonstrating superior resistance recovery capability. In other words, the protection device achieves better resistance reproducibility.

The over-current protection device 10 has a first resistance change rate lower than 1.35, such as 1.35, 1.21, 1.11, 1.03, or 1.09, with a preference for a value lower than 1.2. The over-current protection device 10 has an initial electrical resistance, and has a first electrical resistance when cooled back to room temperature after a thermal treatment for one cycle. The first resistance change rate is obtained by dividing the first electrical resistance by the initial electrical resistance. The over-current protection device 10 has a second resistance change rate lower than 1.63, such as 1.63, 1.57, 1.29, 1.27, or 1.21, with a preference for a value lower than 1.5. The over-current protection device 10 has a second electrical resistance when cooled back to room temperature after the thermal treatment for three cycles, and the second resistance change rate is obtained by dividing the second electrical resistance by the initial electrical resistance. The over-current protection device 10 has a third resistance change rate lower than 1.8, such as 1.16, 1.11, 1.1, or 1.08. After the thermal treatment for three cycles, the over-current protection device 10 is then placed in an environment with a temperature/humidity of 85° C./85% for 504 hours and has a third electrical resistance, and the third resistance change rate is obtained by dividing the third electrical resistance by the second electrical resistance. The over-current protection device 10 has a fourth resistance change rate lower than 2, such as 1.21, 1.14, 1.13, 1.11, or 1.1. After the thermal treatment for three cycles, the over-current protection device 10 is then placed in an environment with a temperature/humidity of 40° C./95% for 504 hours and has a fourth electrical resistance, and the fourth resistance change rate is obtained by dividing the fourth electrical resistance by the second electrical resistance. In contrast, the four resistance change rates of the conventional protection device are much higher than those of the over-current protection device 10 of the present invention.

Please refer to FIG. 4, which shows the top view of the over-current protection device 10 shown in FIG. 3. The over-current protection device has a length A and a width B, and the top-view area “A×B” of the over-current protection device 10 is substantially equivalent to the top-view area of the heat-sensitive layer 11. The heat-sensitive layer 11 may have a top-view area ranging from 2 mm² to 81 mm² based on the size of different products. For example, the top-view area “A×B” may be 1.5×1.5 mm², 2×2 mm², 2.3×2.3 mm², 2.5×3 mm², 2.8×3.5 mm², 4×4 mm², 5×5 mm², 5.1×6.1 mm², 5×7 mm², 7.62×7.62 mm², 8.2×7.15 mm², 7.3×9.5 mm², 7.62×9.35 mm², or 9×9 mm². In addition, the thickness of the heat-sensitive layer 11 in the over-current protection device 10 may range from 0.12 mm to 0.19 mm, such as 0.12 mm, 0.13 mm, 0.14 mm, 0.15 mm, 0.16 mm, 0.17 mm, 0.18 mm, or 0.19 mm. The thickness of each of the upper metal layer 12 and the lower metal layer 13 can be 0.035 mm (i.e., 1 oz), 0.07 mm (i.e., 2 oz), or other sizes, as required. It is understood that the present invention can apply to any size of the over-current protection device 10 described above to achieve the same technical effect. The over-current protection device 10 can be processed into different device types commonly used in the industry, such as surface-mount device (SMD), axial-leaded device (ΔLD), radial-leaded device (RLD), or other device types, depending on the requirements.

In order to provide a more specific description of the technical content of the present invention, Tables 1 to 7 shown below are further discussed using verification data.

TABLE 1

| Before | Mole percentage | | | Weight percentage | |
|---|---|---|---|---|---|
| co-sintering | ratio | WC | CB | WC | CB |
| WC-1 | 20:1 | 95.24% | 4.76% | 99.69% | 0.31% |
| WC-2 | 10:1 | 90.91% | 9.09% | 99.39% | 0.61% |
| WC-3 | 5:1 | 83.33% | 16.67% | 98.79% | 1.21% |
| WC-4 | 1:1 | 50.00% | 50.00% | 94.23% | 5.77% |
| WC-RM | — | 100.00% | 0.00% | 100.00% | 0.00% |

In the present invention, tungsten carbide (WC) is used as the core metal 1. To facilitate coverage of the tungsten carbide by the carbon layer 2, co-sintering is carried out using various ratios of tungsten carbide and carbon black (CB). As shown in Table 1, WC-1, WC-2, WC-3, and WC-4 refer to the groups with different ratios of tungsten carbide to carbon black. In WC-1, the mole percentages between tungsten carbide and carbon black are 95.24% and 4.76% (approximately 20:1), while their weight percentages are 99.69% and 0.31%, respectively. In WC-2, the mole percentages between tungsten carbide and carbon black are 90.91% and 9.09% (approximately 10:1), while their weight percentages are 99.39% and 0.61%, respectively. In WC-3, the mole percentages between tungsten carbide and carbon black are 83.33% and 16.67% (approximately 5:1), while their weight percentages are 98.79% and 1.21%, respectively. In WC-4, the mole percentages between tungsten carbide and carbon black are 50% and 50% (approximately 1:1), while their weight percentages are 94.23% and 5.77%, respectively. WC-RM is served as a control group, and therefore its tungsten carbide is not mixed with carbon black.

TABLE 2

| | | | | | | | Number | |
|---|---|---|---|---|---|---|---|---|
| After | | | | | | | of | |
| Co- | Rᵢ | p | Particle size distribution | | | | carbon | pH |
| sintering | (Ω) | (Ω·cm) | D(0.1) | D(0.5) | D(0.9) | Dₘₐₓ | layers | value |
| WC-1 | 0.001158 | 0.004053 | 1.48 | 2.56 | 4.62 | 8.71 | 0.7 | 6.3 |
| WC-2 | 0.001008 | 0.003528 | 1.54 | 2.86 | 5.02 | 10 | 1 | 7.2 |
| WC-3 | 0.001222 | 0.004277 | 1.55 | 2.98 | 5.22 | 11.48 | 1.6 | 7.9 |
| WC-4 | 0.001587 | 0.005555 | 1.56 | 3.58 | 6.95 | 13.18 | 1.8 | 8.4 |
| WC-RM | 0.001745 | 0.006108 | 1.36 | 2.44 | 4.12 | 7.59 | 0 | 2.7 |

As shown in Table 2, each group is subjected to heat treatment at the same temperature (1250° C.) under a vacuum environment. The coverage of the carbon layer can be observed, and the presence of the carbon layer can be further supported by particle size distribution and pH value measurements. The coverage of the carbon layer can be observed using a Transmission Electron Microscope (TEM), and the coverage area is calculated based on the total surface area of tungsten carbide, which is taken as 100%. For example, in WC-1, carbon black covers 70% of the surface of tungsten carbide, so the number of carbon layers is 0.7 layer. In WC-2, carbon black covers 100% of the surface of tungsten carbide (as illustrated in step S3 in FIG. 2), so the number of carbon layers is 1. In WC-3, carbon black not only fully covers the surface of the tungsten carbide but also continues to accumulate on top of the initial carbon layer, resulting in a total of 1.6 carbon layers. WC-4 is similar to WC-3, and the number of carbon layers of it is 1.8. In contrast, no coverage of the carbon layer is observed in WC-RM.

Particle size distribution is measured by the particle size analyzer (commercialized brand name Malvern Mastersizer 2000). “D” stands for “Distribution of particle size”, and the number within brackets after “D” refers to the proportion of the particles. The total number of particles is taken as 1, so 0.1, 0.5 and 0.9 refer to 10%, 50% and 90%, respectively. For example, D (0.1) means that 10% of particles are smaller than the values of D (0.1) listed in Table 2. D (0.5) and D (0.9) are interpreted in the same way. As for Dₘₐₓ, it refers to the maximum particle diameter (or maximum diameter for simplicity) present among all the particles. In addition, D (0.5) stands for the middle value of particle size distribution, that is, the median diameter. As shown in Table 2, the maximum particle diameter (Dₘₐₓ) ranges from 8.71 μm to 13.18 μm for WC-1, WC-2, WC-3, and WC-4, all of which are larger than the maximum particle diameter (Dₘₐₓ) of WC-RM.

As described above, the pH value of each group is measured. 10 grams of the sample from each group are added to 10 grams of water, followed by ultrasonic agitation for 30 minutes to ensure dispersion. The pH value of it is then measured using a pH meter. As shown in Table 2, in WC-1, WC-2, WC-3, and WC-4, the pH value ranges from 6.3 to 8.4. Apparently, this indicates that tungsten carbide can be protected by carbon black, preventing any unexpected physical or chemical reactions, and thus maintaining a neutral or slightly basic pH value. In contrast, tungsten carbide in WC-RM is unstable and acidic oxides (e.g., tungstic acid) are easily formed, resulting in a pH value of 2.7.

Next, the aforementioned tungsten carbide is applied to the PTC material. The details of the results are shown in the following Tables 3 to 7.

TABLE 3

| | Source | HDPE | WC |
|---|---|---|---|
| Group | of WC | (vol %) | (vol %) |
| E1 | WC-1 | 53 | 47 |
| F2 | WC-2 | 53 | 47 |
| E3 | WC-2 | 55 | 45 |
| E4 | WC-3 | 53 | 47 |
| E5 | WC-4 | 53 | 47 |
| C1 | WC-RM | 53 | 47 |
| C2 | WC-RM | 55 | 45 |

Table 3 shows the composition of the heat-sensitive layer in volume percentages for the groups E1 to E5 (i.e., the embodiments E1 to E5 of the present invention) and the groups C1 and C2 (i.e., the comparative examples C1 and C2). The polymer matrix for each group is high density polyethylene (HDPE), and the conductive filler for each group is tungsten carbide (WC) from different sources. Considering the measurement error and the permissible error tolerance, the percentage of high density polyethylene may range from 50% to 60%, and the percentage of tungsten carbide may range from 40% to 50%. Within the above ranges, the over-current protection device can achieve the same or similar technical effects. The manufacturing process of the over-current protection devices is described below. According to the composition shown in Table 3, materials are prepared and put into HAAKE twin screw blender for blending. The blending temperature is 215° C., the time for pre-mixing is 3 minutes, and the blending time is 15 minutes. The conductive polymer after being blended is pressed into a sheet by a hot press machine at a temperature of 210° C. and a pressure of 150 kg/cm². The sheet is then cut into pieces of about 20 cm×20 cm, and two nickel-plated copper foils are laminated to two sides of the sheet with the hot press machine at a temperature of 210° C. and a pressure of 150 kg/cm², by which a three-layer structure is formed. Then, the sheet with the nickel-plated copper foils is punched into PTC chips, each of which is the over-current protection device. Each sample of the over-current protection device has the length of 2.8 mm and the width of 3.5 mm (i.e., top-view area is 9.8 mm²), and the thickness thereof is 0.28 mm, wherein the thickness of the heat-sensitive layer is 0.14 mm. Then, the PTC chips are subjected to electron beam irradiation of 15 kGy (irradiation dose can be adjusted depending on the requirement). After irradiation, the following measurements are performed by taking fifteen PTC chips as samples to be tested for each group.

TABLE 4

| | Rᵢ | R₁ | Pᵢ | P₁ | R₂ | R₃ | | | |
|---|---|---|---|---|---|---|---|---|---|
| Group | (Ω) | (Ω) | (Ω·cm) | (Ω.cm) | (Ω) | (Ω) | R1/Ri | R2/Ri | R3/Ri |
| E1 | 0.00107 | 0.00116 | 0.00375 | 0.00407 | 0.00124 | 0.00136 | 1.09 | 1.16 | 1.27 |
| E2 | 0.00098 | 0.00101 | 0.00343 | 0.00354 | 0.00109 | 0.00119 | 1.03 | 1.11 | 1.21 |
| E3 | 0.00119 | 0.00132 | 0.00417 | 0.00462 | 0.00143 | 0.00153 | 1.11 | 1.20 | 1.29 |
| E4 | 0.00148 | 0.00179 | 0.00518 | 0.00627 | 0.00204 | 0.00233 | 1.21 | 1.38 | 1.57 |
| E5 | 0.00156 | 0.00211 | 0.00546 | 0.00739 | 0.00233 | 0.00255 | 1.35 | 1.49 | 1.63 |
| C1 | 0.00165 | 0.00198 | 0.00578 | 0.00693 | 0.00222 | 0.00251 | 1.20 | 1.35 | 1.52 |
| C2 | 0.00254 | 0.00376 | 0.00889 | 0.01316 | 0.00411 | 0.00501 | 1.48 | 1.62 | 1.97 |

“Rᵢ” refers to the initial electrical resistance of the over-current protection device at room temperature. In addition, the electrical resistivity formula is ρ=R×A/L, where “R” is electrical resistance, “L” is length (thickness), and “A” is area. Accordingly, the electrical resistivity pi can be calculated based on Rᵢ. As shown in Table 4, the range of electrical resistivity of the embodiments E1 to E5 is below 0.0055 Ω·cm (i.e., from 0.00343 Ω·cm to 0.00546 Ω·cm), indicating that their electrical conductivity is superior to that of the comparative examples C1 and C2.

In practical use, the over-current protection device is assembled onto the substrate by welding. The electrical resistance after assembly, referred to as R₁, is also measured. “R₁” refers to the electrical resistance of the over-current protection device after it has cooled back to room temperature following a reflow process for one cycle. The resistance change rate of the over-current protection device is calculated by dividing R₁ by Rᵢ (i.e., R₁/Rᵢ), which can be used to assess the resistance stability of the device. R₁/Rᵢ corresponds to the first resistance change rate, as previously mentioned. The range of R₁/Rᵢ of the embodiments E1 to E5 is from 1.03 to 1.35, indicating excellent resistance stability. In particular, for the embodiments E1 to E3, the range of R₁/Rᵢ is very close to 1, meaning that the resistance change is minimal and significantly lower than the range of R₁/Rᵢ of the comparative examples C1 and C2.

To further highlight the advantage of the present invention in terms of resistance stability, each group is subjected to the thermal treatment (i.e., reflow process) two additional cycles, and the electrical resistances after the second and third cycles, referred to as R₂ and R₃ respectively, are measured. More specifically, “R₂” refers to the electrical resistance of the over-current protection device after it has cooled back to room temperature following the reflow process for two cycles, and “R₃” refers to the electrical resistance of the over-current protection device after it has cooled back to room temperature following the reflow process for three cycles. As shown in Table 4, the resistance change rate of the over-current protection device remains significantly below 2 (i.e., between 1.21 and 1.63). In particular, in terms of R₃/Rᵢ (corresponding to the second resistance change rate, as previously mentioned), the values in the embodiments E1 to E3 are lower than those in the comparative examples C1 and C2, clearly demonstrating the stability of the present invention.

In addition, the device will be subjected to various environmental stresses during practical use. Therefore, the over-current protection device is tested under different temperature and humidity conditions after three cycles of the reflow process. The details are shown in Table 5 and Table 6.

TABLE 5

Temperature/Humidity (85 °C/85%)

| | R₃ | R_{96 hr} | R_{336 hr} | R_{504 hr} | R_{504 hr}/ |
|---|---|---|---|---|---|
| Group | (Ω) | (Ω) | (Ω) | (Ω) | R₃ |
| E1 | 0.00136 | 0.00147 | 0.00150 | 0.00158 | 1.16 |
| E2 | 0.00119 | 0.00124 | 0.00127 | 0.00132 | 1.11 |
| E3 | 0.00153 | 0.00158 | 0.00164 | 0.00168 | 1.10 |
| E4 | 0.00233 | 0.00240 | 0.00245 | 0.00252 | 1.08 |
| E5 | 0.00255 | 0.00259 | 0.00267 | 0.00275 | 1.08 |
| C1 | 0.00251 | 0.00402 | 0.00452 | 0.00532 | 2.12 |
| C2 | 0.00501 | 0.00797 | 0.00827 | 0.00947 | 1.89 |

In Table 5, each group is placed in an environment with a temperature/humidity of 85° C./85%, and left to stand for different durations (i.e., 96 hours, 336 hours, and 504 hours). Afterward, it is cooled to room temperature, and the electrical resistance for each duration (i.e., R₉₆ hr, R₃₃₆ hr, and R₅₀₄ hr) is measured. In Table 5, R₅₀₄ hr/R₃ corresponds to the third resistance change rate as previously mentioned. In the embodiments E1 to E5, the range of R₅₀₄ hr/R₃ is from 1.08 to 1.16, which is very close to 1, indicating almost no change in electrical resistance. In contrast, the range of R₅₀₄ hr/R₃ in the comparative examples C1 and C2 is around 2, indicating a twofold increase in electrical resistance. From the above, the tungsten carbide filler encapsulated with a carbon layer enables the over-current protection device of the present invention to exhibit excellent resistance stability.

TABLE 6

Temperature/Humidity (40 °C/95%)

| | R₃ | R_{96 hr} | R_{336 hr} | R_{504 hr} | R_{504 hr}/ |
|---|---|---|---|---|---|
| Group | (Ω) | (Ω) | (Ω) | (Ω) | R₃ |
| E1 | 0.00134 | 0.00143 | 0.00145 | 0.00162 | 1.21 |
| E2 | 0.00116 | 0.00125 | 0.00128 | 0.00132 | 1.14 |
| E3 | 0.00150 | 0.00163 | 0.00167 | 0.00170 | 1.13 |
| E4 | 0.00228 | 0.00242 | 0.00246 | 0.00251 | 1.11 |
| E5 | 0.00261 | 0.00279 | 0.00284 | 0.00287 | 1.10 |
| C1 | 0.00259 | 0.00488 | 0.00531 | 0.00663 | 2.56 |
| C2 | 0.00499 | 0.00878 | 0.00918 | 0.01003 | 2.01 |

In Table 6, each group is placed in an environment with a temperature/humidity of 40° C./95%, and left to stand for different durations (i.e., 96 hours, 336 hours, and 504 hours). Afterward, it is cooled to room temperature, and the electrical resistance for each duration (i.e., R₉₆ hr, R₃₃₆ hr, and R₅₀₄ hr) is measured. In Table 6, R₅₀₄ hr/R₃ corresponds to the fourth resistance change rate as previously mentioned. In the embodiments E1 to E5, the range of R₅₀₄ hr/R₃ is from 1.1 to 1.21, which is still very close to 1. In contrast, the range of R₅₀₄ hr/R₃ in the comparative examples C1 and C2 exceeds 2, indicating at least a twofold increase in electrical resistance. The over-current protection device of the present invention still exhibits excellent resistance stability even when placed under the different temperature and humidity conditions from those in Table 5.

According to the present invention, other electrical characteristics of the over-current protection device can be verified.

TABLE 7

| | | 23° C. | | | | 85° C. | | | |
|---|---|---|---|---|---|---|---|---|---|
| | | | | Current | Power | | | Current | Power |
| | | | | endurance | endurance | | | endurance | endurance |
| | | | Leakage | per unit | per unit | | Leakage | per unit | per unit |
| | R₁ | Iₜᵣᵢₚ | current | area | area | Iₜᵣᵢₚ | current | area | area |
| Group | (Ω) | (A) | (A) | (A/mm²) | (W/mm²) | (A) | (A) | (A/mm²) | (W/mm²) |
| E1 | 0.00115 | 9.42 | 0.1948 | 0.961 | 5.767 | 6.14 | 0.0911 | 0.627 | 3.759 |
| E2 | 0.00102 | 9.96 | 0.1990 | 1.016 | 6.098 | 6.66 | 0.0930 | 0.680 | 4.078 |
| E3 | 0.00130 | 8.01 | 0.1846 | 0.817 | 4.904 | 5.04 | 0.0897 | 0.514 | 3.086 |
| E4 | 0.00181 | 7.12 | 0.1774 | 0.727 | 4.359 | 4.08 | 0.0852 | 0.416 | 2.498 |
| E5 | 0.00208 | 6.61 | 0.1662 | 0.674 | 4.047 | 3.62 | 0.0799 | 0.369 | 2.216 |
| C1 | 0.00198 | 7.23 | 0.1801 | 0.738 | 4.427 | 4.76 | 0.0885 | 0.486 | 2.914 |
| C2 | 0.00385 | 5.17 | 0.1986 | 0.528 | 3.165 | 2.84 | 0.0751 | 0.290 | 1.739 |

As described above, R₁ refers to the electrical resistance of the over-current protection device measured after assembly. “Iₜᵣᵢₚ” refers to the minimum current required to trigger the trip event of the over-current protection device. In addition, during the trip event, the current of the over-current protection device may not be completely cut off and a leakage current may still pass through it. “Current endurance per unit area” refers to the value calculated by dividing Iₜᵣᵢₚ by the top-view area of the over-current protection device (i.e., 9.8 mm²). Moreover, since the applied voltage is 6 V, the minimum power required to trigger the trip event per unit area, referred to as “Power endurance per unit area,” can also be obtained. In the embodiments E1 to E5, the values of Iₜᵣᵢₚ range from 6.61 A to 9.96 A at 23° C., which are generally higher than those of the comparative examples C1 and C2. In terms of unit area, both current endurance per unit area and power endurance per unit area of the embodiments E1 to E5 exhibit the same trend at 23° C. Similarly, in the embodiments E1 to E5, the values of Iₜᵣᵢₚ range from 3.62 A to 6.66 A at 85° C., which are also generally higher than those of the comparative examples C1 and C2. In terms of unit area, both current endurance per unit area and power endurance per unit area of the embodiments E1 to E5 also exhibit the same trend at 85° C. From the above, the required current to trip the over-current protection device of the present invention is higher. In other words, the over-current protection device of the present invention allows a larger current to pass through when it is not tripped, withstanding greater applied current and applied power without burnout.

The above-described embodiments of the present invention are intended to be illustrative only. Numerous alternative embodiments may be devised by persons skilled in the art without departing from the scope of the following claims.

What is claimed is:

1. An over-current protection device, comprising:
an electrode layer having a top metal layer and a bottom metal layer; and
a heat-sensitive layer laminated between the top metal layer and the bottom metal layer, wherein the heat-sensitive layer exhibits a positive temperature coefficient (PTC) characteristic and comprises:
a polymer matrix comprising a polyolefin-based polymer; and
a conductive filler comprising a metal-containing material dispersed in the polymer matrix, thereby forming an electrically conductive path in the heat-sensitive layer, wherein the metal-containing material has a core metal and a carbon layer covering the core metal, wherein the total surface area of the core metal is taken as 100%, and the carbon layer covers more than 60% of the total surface area of the core metal.

2. The over-current protection device of claim 1, wherein the carbon layer completely wraps the core metal, such that the core metal is enclosed by at least one layer of the carbon layer.

3. The over-current protection device of claim 2, wherein a pH value of the metal-containing material ranges from 6 to 9.

4. The over-current protection device of claim 3, wherein a maximum diameter of the metal-containing material is greater than 8 μm.

5. The over-current protection device of claim 4, wherein the maximum diameter of the metal-containing material ranges from 8 μm to 13.5 μm.

6. The over-current protection device of claim 1, wherein the total volume of the heat-sensitive layer is taken as 100%, with the polyolefin-based polymer accounting for 50% to 60% and the conductive filler accounting for 40% to 50%.

7. The over-current protection device of claim 1, wherein the core metal is tungsten carbide.

8. The over-current protection device of claim 1, wherein the polyolefin-based polymer is selected from the group consisting of low density polyethylene (LDPE), medium density polyethylene (MDPE), high density polyethylene (HDPE), linear low-density polyethylene (LLDPE), polypropylene, and polybutene.

9. The over-current protection device of claim 1, wherein the heat-sensitive layer does not comprise a flame retardant.

10. The over-current protection device of claim 1, wherein the polymer matrix does not comprise a fluoropolymer, wherein the fluoropolymer is selected from the group consisting of polyvinylidene difluoride, polytetrafluoroethylene, ethylene-tetrafluoroethylene copolymer, tetrafluoroethylene-hexafluoro-propylene copolymer, perfluoroalkoxy modified tetrafluoroethylenes, poly(chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, and vinylidene fluoride-hexafluoropropylene-tetrafluoroethylene terpolymer, and a mixture or copolymer of combinations thereof.

11. The over-current protection device of claim 1, wherein the over-current protection device has a first resistance change rate lower than 1.2, wherein:
the over-current protection device has an initial electrical resistance;
the over-current protection device has a first electrical resistance when cooled back to room temperature after a thermal treatment for one cycle; and
the first resistance change rate is obtained by dividing the first electrical resistance by the initial electrical resistance.

12. The over-current protection device of claim 1, wherein the over-current protection device has a second resistance change rate lower than 1.5, wherein:
the over-current protection device has an initial electrical resistance;
the over-current protection device has a second electrical resistance when cooled back to room temperature after a thermal treatment for three cycles; and
the second resistance change rate is obtained by dividing the second electrical resistance by the initial electrical resistance.

13. The over-current protection device of claim 12, wherein the over-current protection device has a third resistance change rate lower than 1.8, wherein:
after the thermal treatment for three cycles, the over-current protection device is then placed in an environment with a temperature/humidity of 85° C./85% for 504 hours and has a third electrical resistance; and
the third resistance change rate is obtained by dividing the third electrical resistance by the second electrical resistance.

14. The over-current protection device of claim 12, wherein the over-current protection device has a fourth resistance change rate lower than 2, wherein:
after the thermal treatment for three cycles, the over-current protection device is then placed in an environment with a temperature/humidity of 40° C./95% for 504 hours and has a fourth electrical resistance; and
the fourth resistance change rate is obtained by dividing the fourth electrical resistance by the second electrical resistance.

15. The over-current protection device of claim 1, wherein at room temperature, the over-current protection device has a current endurance per unit area ranging from 0.6 A/mm² to 1.1 A/mm², and has a power endurance per unit area ranging from 3.6 W/mm² to 7 W/mm².

16. The over-current protection device of claim 1, wherein at 85° C., the over-current protection device has a current endurance per unit area ranging from 0.3 A/mm² to 0.7 A/mm², and has a power endurance per unit area ranging from 2.2 W/mm² to 5 W/mm².

17. The over-current protection device of claim 1, wherein the over-current protection device has a top-view area ranging from 2 mm² to 81 mm².

18. The over-current protection device of claim 1, wherein the heat-sensitive layer has a thickness ranging from 0.12 mm to 0.19 mm.
